(19) United States
(12) Patent Application Publication
(10) Pub. No.: US 2016/0034558 A1
(43) Pub. Date: Feb. 4, 2016

(54) GENERATING A CLUSTERING MODEL AND CLUSTERING BASED ON THE CLUSTERING MODEL

(71) Applicant: INTERNATIONAL BUSINESS MACHINES CORPORATION, Armonk, NY (US)

(72) Inventors: Ning Duan, Beijing (CN); Yuan Ni, Shanghai (CN); Zhi Hu Wang, Beijing (CN); Junchi Yan, Shanghai (CN); Hui Jia Zhu, Shangahi (CN)

(21) Appl. No.: 14/812,141

(22) Filed: Jul. 29, 2015

(30) Foreign Application Priority Data
Jul. 31, 2014 (CN) 201410373109.X

(51) Int. Cl. G06F 17/30; G06N 99/00

(52) U.S. Cl. CPC G06F 17/30598; G06N 99/005

(57) ABSTRACT

Methods and an apparatus for generating a clustering model and clustering based on the clustering model. The first method includes: extracting feature information of each of a plurality of historical messages in response to receiving the plurality of historical messages from a historical voice conversation; obtaining a correlation between the plurality of historical messages; and generating a clustering model that clusters the plurality of historical messages on the basis of the correlation and the feature information of each of the plurality of historical messages. A second method for using the clustering model is also provided. According to the present invention, a reliable and accurate clustering model is generated through which a plurality of messages is clustered and displayed on the basis of the clustering model.

### CROSS REFERENCE

This application claims priority under 35 U.S.C. §119 from Chinese Patent Application No. 201410373109.X filed Jul. 31, 2014, the entire contents of which are incorporated herein by reference.

### FIELD OF INVENTION

The present invention relates to message processing. More specifically, to methods and an apparatus for generating a clustering model and clustering on the basis of the clustering model.

### BACKGROUND

With the development of communication technology, various communication applications have been developed so far. Users can communicate by means of communication applications such as instant messaging applications (e.g., Wechat, Sametime, QQ, etc.), short message applications, chat room applications and so on. These communication applications can be run on computer devices (e.g., computers, laptops, tablet PCs, intelligent terminals, mobile terminals, etc.) with communication capability, and a user can communicate with one or more other users via these communication applications.

Unlike the traditional continuous voice communication, users can use these communication applications to communicate at discrete time points, and two successive messages might relate to different themes. For example, a user Alan can send a message “is the weather in Beijing good?” to a user Teresa; after receiving the message from Alan, perhaps Teresa does not immediately answer Beijing's weather conditions but might successively send several greeting messages to Alan, and ask “when will you come to Beijing?” before replying to Alan with “It is raining in Beijing.”

As seen from the above example, in a conversation proceeding by the communication application, two or more successive messages from two users do not discuss the same theme all the while but can involve a plurality of relevant or irrelevant themes (e.g., weather, traffic, education, sports and other contents). In group chatting, a plurality of users might discuss more themes at the same time. When presenting messages from various users one after another in temporal order according to the prior art, users cannot quickly learn correlations between these messages; in particular, page display chaos will be caused when the users are using devices like mobile terminals whose display screen is limited in size.

In addition, current communication applications can support users to send voice messages. For example, a user can record a voice message when pressing a “voice” button in the communication application, and send the voice message to one or more other users when releasing the “voice” button. The voice message can be displayed as a special icon at a receiver's user device, and the receiver can listen to the recorded voice when pressing the icon. When two or more users communicate by means of voice, it is impossible to tell, on display screens of user devices, which voice messages relate to the same theme. At this point, these users have to sequentially listen to each voice messages, which will take huge time.

Therefore, how to differentiate a plurality of messages from two or more users by theme involved in each message becomes a research focus nowadays.

### SUMMARY

Therefore, it is desired to develop a technical solution for generating, on the basis of features of a conversation in a communication application, a clustering model capable of clustering a plurality of messages in the conversation. Further, it is desired to develop a technical solution for clustering a plurality of messages in a current conversation on the basis of a clustering model being generated.

The present invention provides a method for generating a clustering model. The method includes: extracting feature information from each of a plurality of historical messages in response to receiving the plurality of historical messages from a historical voice conversation and obtaining a correlation between the plurality of historical messages. Then, generating a clustering model that clusters the plurality of historical messages on the basis of the correlation and the feature information of each of the plurality of historical messages.

Additionally, the present invention provides a method for clustering a plurality of current messages in a current conversation based on a clustering model generated by a plurality of historical messages in a historical conversation. The method includes: extracting feature information of each of a plurality of historical messages from a historical voice conversation; obtaining a correlation between the plurality of historical messages; generating a clustering model that clusters the plurality of historical messages on the basis of the correlation and feature information of each of the plurality of historical messages; extracting feature information of each of the plurality of current messages; and clustering the plurality of current messages to at least one theme group on the basis of the feature information of each of the plurality of current messages by using the generated clustering model.

The present invention also provides an apparatus for generating a clustering model. The apparatus includes: an extracting module configured to extract feature information of each of a plurality of historical messages in response to receiving the plurality of historical messages from a historical voice conversation; an obtaining module configured to obtain a correlation between the plurality of historical messages; and a generating module configured to generate a clustering model that clusters the plurality of historical messages on the basis of the correlation and the feature information of each of the plurality of historical messages.

With the methods and apparatus of the present invention, a clustering model for clustering a plurality of messages can be generated efficiently and accurately. Further, with the present invention, a plurality of current messages in a current conversation can be clustered to at least one theme group on the basis of the clustering model, messages in various groups can be displayed on the basis of custom information of various users, and further unresponsive messages in groups can be highlighted.

### BRIEF DESCRIPTION OF THE SEVERAL VIEWS OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 schematically depicts an exemplary computer system/server which is applicable to implement the embodiments of the present invention;

FIG. 2 schematically depicts an exemplary cloud computing environment;

FIG. 3 schematically depicts abstraction model layers provided by cloud computing environment (FIG. 2);

FIG. 4 schematically depicts an interface for displaying a plurality of messages in a conversation according to one technical solution;

FIG. 5 schematically depicts a block diagram of a technical solution for generating a clustering model according to one embodiment of the present invention, and schematically depicts a block diagram of a technical solution for clustering a plurality of current messages in a current conversation on the basis of the generated clustering model according to one embodiment of the present invention;

FIG. 6A schematically depicts a flowchart of a method for generating a clustering model according to one embodiment of the present invention.

FIG. 6B schematically depicts a flowchart of a method for clustering a plurality of current messages in a current conversation on the basis of the generated clustering model according to one embodiment of the present invention;

FIG. 7 depicts a schematic view of an interface for display the plurality of clustered current messages according to one embodiment of the present invention;

FIG. 8 depicts a schematic view of an interface for displaying the plurality of clustered current messages according to another embodiment of the present invention;

FIG. 9A schematically depicts a block diagram of an apparatus for generating a clustering model according to one embodiment of the present invention.

FIG. 9B schematically depicts a block diagram of an apparatus for clustering a plurality of current messages in a current conversation on the basis of the generated clustering model according to one embodiment of the present invention.

### DETAILED DESCRIPTION

Some preferable embodiments of the present invention will be described in more detail with reference to the accompanying drawings. However, the present invention can be implemented in various manners, and thus should not be construed to be limited to the embodiments disclosed herein. On the contrary, those embodiments are provided for the thorough and complete understanding of the present invention, and completely conveying the scope of the present invention to those skilled in the art.

It is understood in advance that although the present invention includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

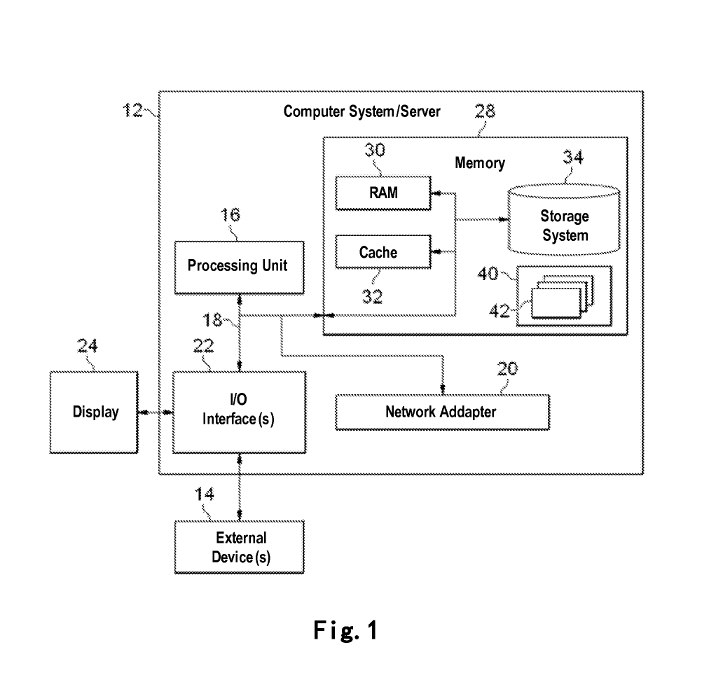

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is computer system/server 12, which is operational with numerous other general purpose or special purpose computing system environments or configurations. Examples of well-known computing systems, environments, and/or configurations that can be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 12 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 1, computer system/server 12 in cloud computing node 10 is shown in the form of a general-purpose computing device. The components of computer system/server 12 can include, but are not limited to, one or more processors or processing units 16, system memory 28, and bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). A magnetic disk drive (not shown) can be provided for reading from and writing to a removable, non-volatile magnetic disk (e.g., a “floppy disk”). Also, an optical disk drive (not shown) can be provided for reading from or writing to a removable, non-volatile optical disk such as a CD-ROM, DVD-ROM or other optical media. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

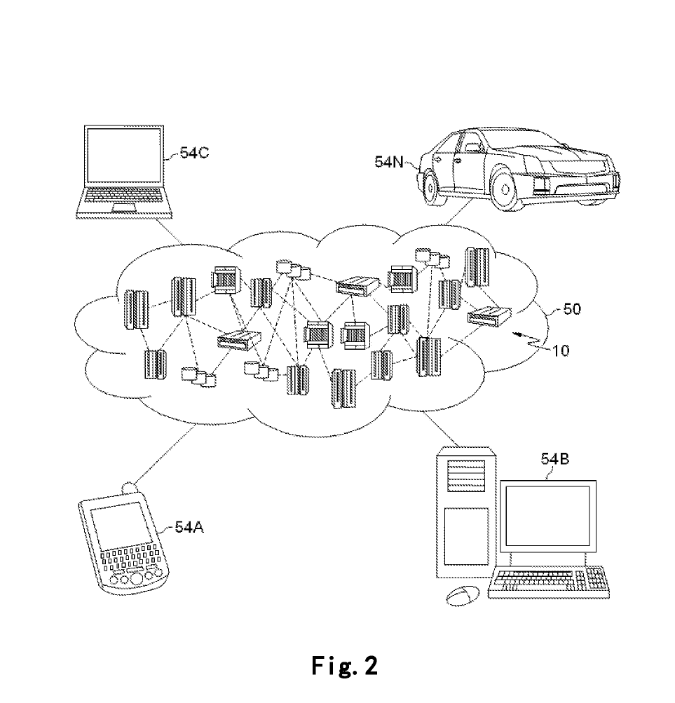

Referring now to FIG. 2, illustrative cloud computing environment 50 is depicted. As shown, cloud computing environment 50 includes one or more cloud computing nodes 10 with which local computing devices used by cloud consumers can communicate. The local computing devices can be, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

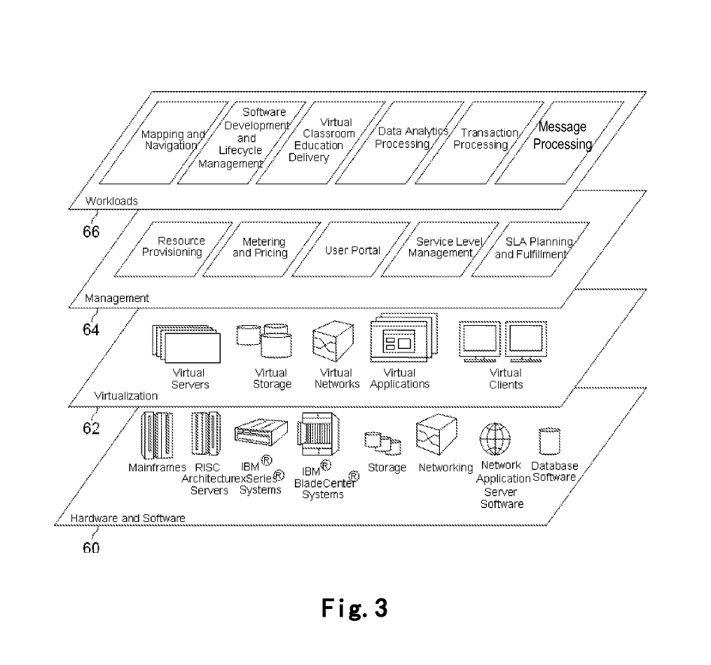

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes (e.g. IBM® zSeries® systems); RISC (Reduced Instruction Set Computer) architecture based servers (e.g., IBM pSeries® systems); IBM xSeries® systems; IBM BladeCenter® systems; storage devices; networks and networking components. Examples of software components include network application server software (e.g., IBM WebSphere® application server software); and database software (e.g., IBM DB2® database software). (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities can be provided: virtual servers; virtual storage; virtual networks, including virtual private networks; virtual applications and operating systems; and virtual clients.

In one example, management layer 64 can provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment can be utilized. Examples of workloads and functions which can be provided from this layer include: mapping and navigation; software development and lifecycle management; virtual classroom education delivery; data analytics processing; transaction processing; and message processing.

In one embodiment of the present invention, the technical solution for message processing according to various embodiments of the present invention can be implemented at workloads layer 66, so as to generate a clustering model for clustering a plurality of messages in the cloud computing environment conveniently, efficiently and accurately; further, a plurality of messages in a conversation can be clustered on the basis of the generated clustering model, and subsequently the clustered messages are displayed in a user-customized manner. Specifically, the technical solution of the present invention can be implemented at server end of the communication application.

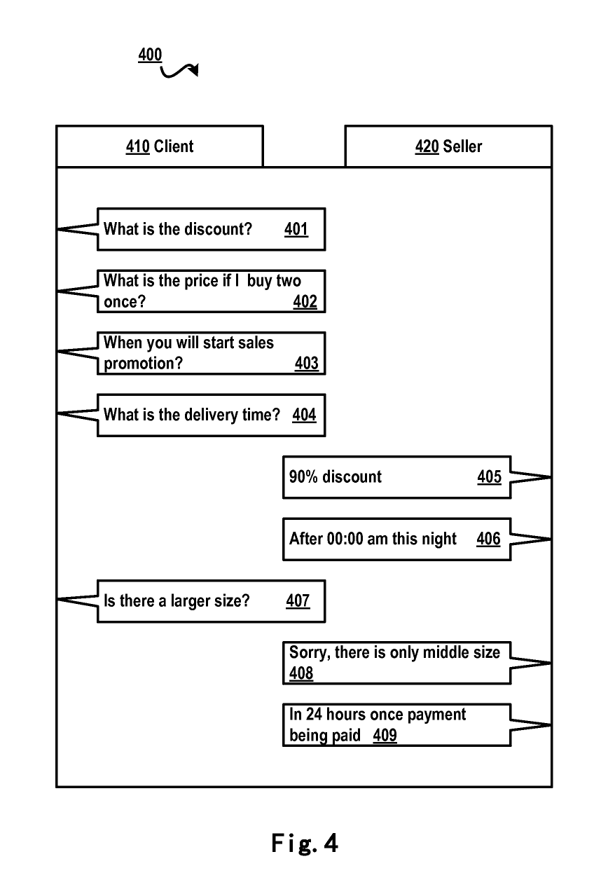

FIG. 4 schematically shows an interface 400 for displaying a plurality of messages in a conversation according to one technical solution. Specifically, FIG. 4 schematically shows a diagram of a conversation between a client 410 and a seller 420 in online shopping. Client 410 successively sends 4 messages (i.e., messages 401 to 404) to seller 420 for inquiring information on four themes, namely discount, price, sales promotion and delivery. Next, seller 420 sends a message 405 to respond to message 401 and sends a message 406 to respond to message 403. Subsequently, client 410 sends a message 407 to inquire information on size. Finally, seller 420 sends messages 408 and 409 to respond to messages 407 and 404, respectively.

As seen from the example in FIG. 4, questions and answers associated with various themes are interlace-displayed in the display interface, and the user (either client 410 or seller 420) can hardly get the correspondence relationship between questions and answers. Further note although client 410 sends message 402 to ask “what is the price if I buy two once?,” due to the display chaos in the display interface, seller 420 does not notice message 402 or give an answer.

The example in FIG. 4 only shows a conversation between two users. Those skilled in the art should understand when the conversation involves more users and more themes, the display effect in the interface will become more complex. On a mobile terminal whose display screen is rather limited in size, it is especially more difficult to differentiate between various themes that are in discussion between users.

So far technical solutions have been developed for obtaining a message by text analysis of the message. In one technical solution, key words in various messages can be analyzed so as to differentiate between themes involved in these messages. However, since the language in conversations is usually oral expression and there are a large amount of phrases having the same meaning but different expression (for example, car and automobile have the same meaning in some language environment), it is difficult to accurately learn themes of messages purely on the basis of key words analysis.

In addition, a technical solution of “@username” has also been proposed. When a conversation involves multiple users, a current user sends a message to a given user by inserting “@username” into the message. For example, users Alan and Teresa are currently in a conversation with other users. When Teresa wants to remind Alan that her message is an answer to Alan's question, Teresa can send a message “@Alan it is raining in Beijing.” At Alan's client, the message will be highlighted so as to be differentiated from messages from others users in the conversation.

Although “@username” makes it possible for the receiver to differentiate a certain message sent from the sender from many messages, this technical solution requires the sender to manually add “@username” to a message. In addition, when the interaction between the sender and the receiver relates to a plurality of messages, this technical solution still cannot differentiate the plurality of messages from other messages.

In view of many drawbacks in the prior art, it is desired to generate a clustering model, and it is desired the clustering model can automatically cluster a plurality of messages according to themes discussed by messages. Specifically, in one embodiment of the present invention, there is proposed a method for generating a clustering model, including: in response to receiving a plurality of historical messages from a historical voice conversation, extracting feature information of each of the plurality of historical messages; obtaining a correlation between the plurality of historical messages; and generating, on the basis of the correlation and the feature information of each of the plurality of historical messages, a clustering model that clusters the plurality of historical messages.

In one embodiment of the present invention, there is further proposed a method for clustering a plurality of current messages in a current conversation in response to receiving the plurality of current messages in the current conversation based on a clustering model generated by a plurality of historical messages in a historical conversation. The method includes: extracting feature information of each of a plurality of historical messages from a historical voice conversation; obtaining a correlation between the plurality of historical messages; generating a clustering model that clusters the plurality of historical messages on the basis of the correlation and feature information of each of the plurality of historical messages; extracting feature information of each of the plurality of current messages; and clustering the plurality of current messages to at least one theme group on the basis of the feature information of each of the plurality of current messages by using the generated clustering model.

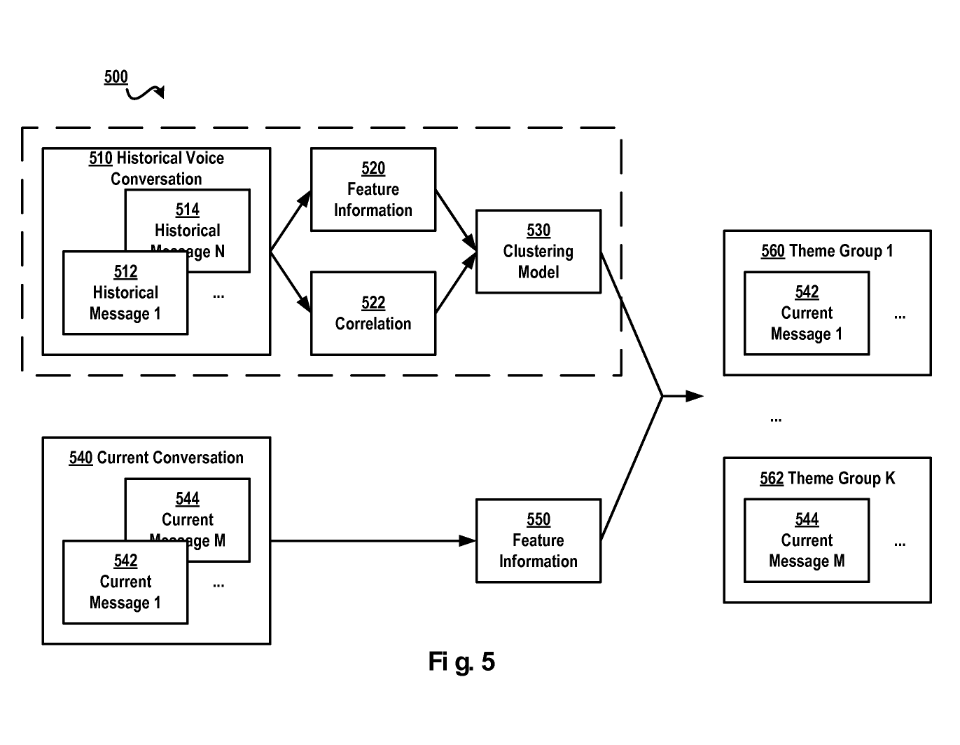

FIG. 5 schematically shows block diagram 500 of a technical solution for generating a clustering model and clustering a plurality of current messages in a current conversation on the basis of the generated clustering model. The principle of the present invention is to cluster a plurality of messages in a conversation to different themes on the basis of a clustering algorithm, at which point how to generate an accurate and reliable clustering model is a key factor. In addition, the clustering model is a technology that gradually increases the clustering accuracy by training, so it is a challenge regarding how to select training data for training the clustering model.

Those skilled in the art should understand unlike sending messages by a communication application like Wechat, a talk between various users in a voice conversation is usually continuous. For example, a voice conversation can include voice fragments of following types: question type (represented as Q), answer type (represented as A), and statement type (represented as S).

In a voice conversation, a fragment of question type from one user is immediately followed by a fragment of answer type from another user. For example, if user 1 asks user 2, “is the weather in Beijing good?” then user 2 will immediately answer “it is raining Beijing.” When two users in the conversation are represented by superscripts 1 and 2, respectively, voice fragments in the conversation with respect to the same theme from the two users can be represented as S¹S²Q¹A²S¹S². That is, these voice fragments represent a statement from user 1, a statement from user 2, a question from user 1, an answer from user 2, a statement from user 1, and a statement from user 2. On the basis of these features in the voice conversation, training data for generating a clustering model can be extracted from a historical voice conversation.

The box on the top left of FIG. 5 schematically shows a block diagram of a technical solution for generating a clustering model. A plurality of historical messages, i.e., historical message 1 512 to historical message N 514 can be extracted from historical voice conversation 510. It is appreciated that, here historical voice conversation 510 can be one voice conversation or a plurality of voice conversations, and the embodiments of the present invention are not intended to limit whether various voice conversations are conversations between the same or different users.

It is appreciated that, in the context of the present invention “one voice conversation” and “a plurality of voice conversations” should be interpreted in a broad sense. For example, suppose users Alan and Teresa have a 20-minute-long phone talk, then the 20-minute-long phone talk is one voice conversation. For another example, if short breaks are caused in the 20-minute-long voice conversation for reasons like signal quality, then it can further be considered the 20-minute-long voice conversation consists of a plurality of voice conversations caused by voice breaks.

In the embodiments of the present invention, it is not intended to limit a source of the historical voice conversation. For example, on the premise of not impairing user privacy, the historical voice conversation can be obtained from face-to-face talks, a voice service center or the user's historical voice calls. In the embodiments of the present invention, it is also not intended to limit the historical voice conversation is a conversation between whom. The historical voice conversation can be a conversation between users using a communication application, or a conversation between irrelevant persons, for example, from a dialogue from a movie.

In one embodiment of the present invention, a personalized clustering model for a specific user can be generated on the basis of a historical voice conversation from the specific user. For example, to obtain the expression habit of a specific user, the user can provide a historical voice conversation to generate training data. Specifically, under the permission of a user and other user with whom the user makes a voice call, a historical voice conversation can further be obtained on the basis of a historical voice call between these users. The training data obtained in this manner can more accurately reflect the language habit of the user, and thus a more accurate and reliable clustering model can be generated for the user.

Next, feature information 520 can be extracted from each historical message. In the embodiments of the present invention, the feature information is information that can distinguish one message from other message, for example, the feature information can include multiple dimensions. Description is presented below to how to extract feature information by means of concrete example. In addition, correlation 522 between the plurality of historical messages can further be obtained. The correlation describes relevance between two historical messages, for example, Q¹A² between the above two successive voice fragments have a correlation. Subsequently, clustering model 530 is generated on the basis of feature information 520 and correlation 522, which clustering model 530 can cluster historical messages with a correlation to one theme group and cluster historical messages without a correlation to different groups.

FIG. 5 further shows a block diagram of a technical solution for clustering a plurality of current messages in a current conversation from a communication application on the basis of generated clustering model 530. Current conversation 540 is for example the conversation in the example shown in FIG. 4, which current conversation 540 can include a plurality of current messages, i.e., current message 1 542 to current message M 544. At this point, feature information 550 can be extracted from current message 1 542 to current message M 544 by the same method as from historical message 1 512 to historical message N 514. Subsequently, feature information 550 is clustered on the basis of clustering model 530, i.e., current message 1 542 to current message M 544 corresponding to feature information 550 are clustered to a plurality of theme groups. For example, theme group 1 560 can include current message 1 542 and so on, theme group K 562 can include current message M 544 and so on.

Since historical messages extracted from the historical voice conversation are coherent and usually have a clear correlation (e.g., relate to the same theme), the clustering model generated on the basis of the historical voice conversation is quite accurate. In subsequent operation, a plurality of current messages from a current conversation can be clustered using the generated clustering model, i.e., the plurality of current messages can be clustered to corresponding theme groups.

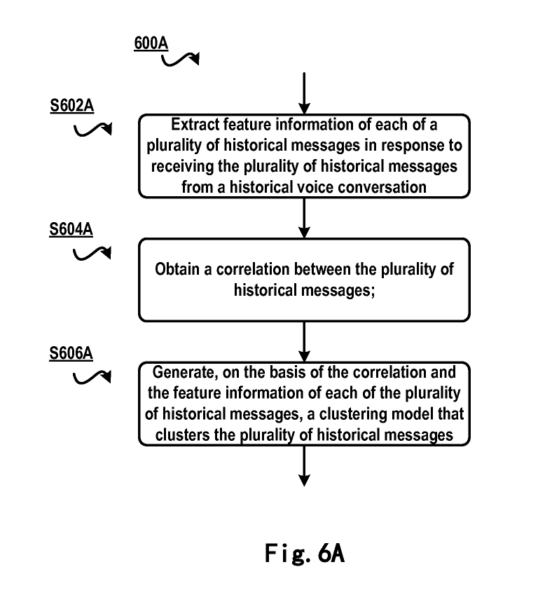

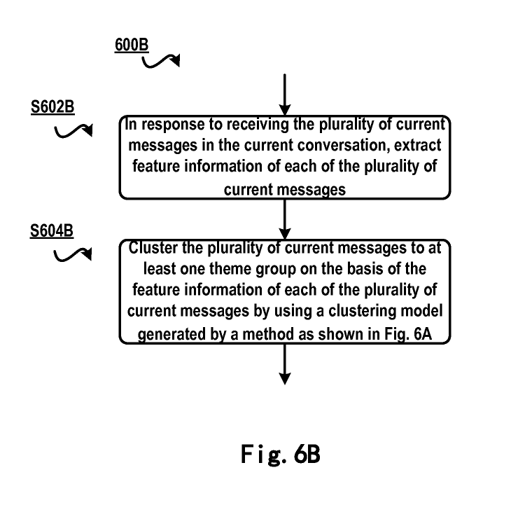

FIG. 6A schematically shows block diagram 600A of a method for generating a clustering model according to one embodiment of the present invention. Specifically, in step S602A, in response to receiving a plurality of historical messages from a historical voice conversation, feature information of each of the plurality of historical messages is extracted. In this embodiment, the historical message in the historical voice conversation can be in voice format; to make it convenient to analyze content of the historical message, first the message in voice format can be converted into a message in text format. Those skilled in the art can perform conversion by using various voice-to-text conversion techniques that are known in the prior art or to be developed later, and conversion details will be omitted in the context of the present invention.

Subsequently, the converted text message is processed. The feature information can be understood as an identifier distinguishing one message from other messages, and can include multiple dimensions for representing the message's features in various respects, such as the message's text content, the message's time, etc. Those skilled in the art can define concrete content of the feature information on the basis of the needs of a concrete application environment. For example, the feature information of the historical message can be represented using a multidimensional vector.

In step S604A, a correlation between the plurality of historical messages is obtained. Since the voice conversation is coherent, and several successive historical messages in the voice conversation usually discuss the same theme, the correlation between the plurality of historical messages can be obtained on the basis of temporal order of the plurality of historical messages. It is appreciated that, the steps of extracting feature information and obtaining a correlation are successively shown in steps S602A and S604A in the context of the present invention, these two steps can be executed in other order, for example, they can be executed in parallel or first a correlation is obtained and then feature information is extracted.

In step S606A, a clustering model for clustering the plurality of historical messages is generated on the basis of the correlation and the feature information of each of the plurality of historical messages. Those skilled in the art can execute this step by using a method for generating a clustering model in the prior art. For example, an initial clustering model can be constructed, and then the initial clustering model is trained using the feature information and the correlation obtained in step S602A and step S604A as training data, so as to obtain an ultimate clustering model.

It should be understood that the selection of training data is an important factor affecting the accuracy of the clustering model. In the present invention, the historical voice conversation is used as the source of training data so that it can be ensured to a great extent that the training data is accurate and reliable. Therefore, the clustering model generated by the method according to the embodiment of the present invention is also accurate.

In one embodiment of the present invention, the obtaining a correlation between the plurality of historical messages includes: identifying historical messages that discuss the same theme among the plurality of historical messages as having the correlation.

It is appreciated that, usually two successive historical messages in the historical voice conversation discuss the same theme. Thereby, two successive historical messages can be extracted from the historical voice conversation and identified as having the correlation. Continuing the above voice fragment example, in the voice fragment S¹S²Q¹A²S¹S², Q¹ and A² are two successive historical messages and represent a question from user 1 and an answer from user 2 respectively, at which point the two historical messages have the correlation.

Relationships between historical messages can include two types: having a correlation and having no correlation. Continuing the above voice fragment example, suppose the first voice fragment S¹S²Q¹A²S¹S² on one theme is immediately followed by a second voice fragment Q¹A²S¹S²S¹S²on another theme, then at this point it can be considered various historical messages in the first voice fragment have a correlation, while historical messages in the first voice fragment and historical messages in the second voice fragment have no correlation. For example, A² in the first voice fragment S¹S²Q¹A²S¹S² and Q² in the second voice fragment Q¹A²S¹S²S¹S² have no correlation. In this manner, two types of training data can be constructed.

In one embodiment of the present invention, the generating, on the basis of the correlation and the feature information of each of the plurality of historical messages, a clustering model that clusters the plurality of historical messages includes: training the clustering model on the basis of the feature information and the correlation so that the clustering model clusters historical messages having the correlation to one theme group.

Through the above steps, the feature information of each historical message has been extracted, and the correlation between various historical messages has been obtained to identify whether various historical messages belong to the same theme. Therefore, the feature information and the correlation can be used to train the clustering model, and historical messages having the correlation are clustered to one theme group. The embodiments of the present invention are not intended to limit a concrete embodiment of the clustering model, but those skilled in the art can use various clustering models that are known in the prior art or to be developed later.

In one embodiment of the present invention, the extracting the feature information of each of the plurality of historical messages in response to receiving a plurality of historical messages from a historical voice conversation, includes: with respect to a current historical message among the plurality of historical messages, obtaining topic information of the current historical message; obtaining attribute information of the current historical message; and integrating the topic information with the attribute information to form feature information of the historical message.

In one embodiment of the present invention, the feature information of a message can include contents in multiple respects, for example, can include topic information, and can further include the attribute information of the message itself. By integrating contents in these two respects, the feature information of the message can be described from multiple perspectives, and further the feature information can describe the original message more accurately. In one embodiment of the present invention, the topic information can be obtained on the basis of latent semantic analysis (LSA).

Latent semantic analysis is an indexing and searching method. Based on the principle of traditional vector space model, the method represents terms and documents by using vectors and judges relationships between terms and documents by relationships (e.g., angle) between vectors. Further, LSA can map terms and documents to a latent semantic space, thereby removing “noise” in an original vector space and further increasing the accuracy of information searching.

In one embodiment of the present invention, on the basis of the principle of LSA, the historical messages (corresponding to documents in LSA) and the phrases (corresponding to terms in LSA) in the historical messages can be mapped to the latent semantic space, and thereby topic information of the historical messages is extracted. It is appreciated that, in the context of the present invention, the topic information refers to information (for example, can be represented as a multidimensional vector) related to semantics as extracted from the historical message, which differs from the above theme information on weather, traffic, education and sports.

Detailed description is presented below to how to obtain topic information attribute information by means of a concrete example. In one embodiment of the present invention, the obtaining the topic information of the current historical message includes: obtaining a topic vector describing the historical message; and clustering the topic vectors so as to obtain topic clustering indicators to which the topic vectors belongs, the topic information including the topic vector and the topic clustering indicator.

Specifically, the plurality of historical messages can be analyzed to build a term-document matrix, singular value decomposition (SVD) is applied to the term-document matrix, the decomposed matrix is subject to dimensionality reduction (i.e., low order approximation), and finally the dimensionality-reduced matrix is used to build a latent semantic space or rebuild the term-document matrix and further obtain topic vectors.

In one embodiment of the present invention, topic vectors from various historical messages can be clustered on the basis of an existing clustering model, and a topic vector and a topic clustering indicator to which the topic vector belongs are used as topic information. In one embodiment of the present invention, any of a topic vector and a topic clustering indicator to which the topic vector belongs can further be used as topic information.

Those skilled in the art can implement the above steps on the basis of the general principle of LSA. Regarding more details of LSA, those skilled in the art can refer to http://en.wikipedia.org/wiki/Latent_semantic_analysis, and further description will be omitted throughout the context of the present invention. It is appreciated that, although in the context of the present invention description is presented to the concrete embodiment of how to obtain topic information by means of a concrete example, those skilled in the art can further obtain topic information on the basis of other algorithms that are currently known and/or to be developed later, which will not be detailed.

In one embodiment of the present invention, the obtaining the attribute information of the current historical message includes: parsing the attribute information of the current historical message from time-series information of the plurality of historical messages in the conversation, the attribute information including at least one of: time of the current historical message, and a distance between the current historical message and other historical message among the plurality of historical messages.

The attribute information can include time of the current historical message (e.g., time when the sender sends the current historical message, or time when a server of the communication application receives the current historical message, etc.). Time difference between two historical messages can describe the possibility that the two historical messages belong to the same theme. The voice conversation is a continuous conversation between two users, and when one user asks a question, usually the other user will immediately answer the question, so typically there is quite a small time difference between the question and the answer. The larger the time difference is, the smaller the possibility that two historical messages belong to the same theme is.

The attribute information can include a distance between the current historical message and other historical message. For example, if a sequence of a plurality of historical messages is M1 to M6, then it can be defined a distance between a historical message M1 and a historical message M2 is 1, a distance between historical message M1 and a historical message M3 is 2, a distance between historical message M2 and historical message M3 is 1, and so on and so forth. The distance between two historical messages can also describe the possibility that the two historical messages belong to the same theme. For example, after one user asks a question, the other user gives an answer immediately, so the distance between the question and the answer is usually 1. Therefore, the larger the distance between messages (i.e., the larger number of other messages between two messages) is, the smaller the possibility that the two messages belong to the same theme is.

In one embodiment of the present invention, the obtaining the attribute information of the current historical message includes: comparing text of the current historical message with text of other historical message among the plurality of historical messages to obtain the attribute information of the current historical message, the attribute information including at least one of: linguistic feature information, n-gram based similarity information, and semantics based similarity information. In this embodiment, text contents of two historical messages are compared to obtain the historical message's features in different respects. Those skilled in the art can extract linguistic feature information, n-gram based similarity information, and semantics based similarity information of various historical messages on the basis of an algorithm that is known in the prior art or to be developed later.

In one embodiment of the present invention, the feature information of the historical message can be represented as a multidimensional vector as below: (topic vector, topic clustering indicator to which the topic vector belongs, time, distance, linguistic feature information, n-gram based similarity information, and semantics based similarity information). In one embodiment of the present invention, the feature information can further include more or less dimensions on the basis of the needs of a concrete application environment.

As description has been presented above to detailed steps of generating a clustering model on the basis of a historical voice conversation with reference to the accompanying drawings, detailed description is presented below to how to cluster a plurality of messages in a conversation on the basis of the generated model. In one embodiment of the present invention, there is proposed a method for clustering a plurality of current messages in a current conversation, including: in response to receiving the plurality of current messages in the current conversation, extracting feature information of each of the plurality of current messages; and clustering the plurality of current messages to at least one theme group on the basis of the feature information of each of the plurality of current messages by using a clustering model generated according to a method of the present invention.

FIG. 6B schematically shows flowchart 600B of a method for clustering a plurality of current messages in a conversation on the basis of the generated clustering model according to one embodiment of the present invention. The conversation in FIG. 6B refers to a conversation that is carried out using various communication applications (e.g., Wechat). Specifically, in step S602B in response to receiving the plurality of current messages in the current conversation, feature information of each of the plurality of current messages is extracted. In this step, the method for extracting the feature information is the same as the method shown in step S602A in FIG. 6 and thus is not detailed here.

In step S604B, the plurality of current messages are clustered to at least one theme group on the basis of the feature information of each of the plurality of current messages by using a clustering model generated according to a method of the present invention. In the context of the present invention, the at least one theme can be theme groups associated with the clustering model. Alternatively, when the current conversation involves a theme that has not appeared in the clustering model, according to the concrete embodiment, the at least one theme group can further include a newly created theme group.

The clustering model in this step is a clustering model that is generated on the basis of a historical voice conversation and is quite reliable and accurate. Therefore, the plurality of current messages in the current conversation can be reliably and accurately clustered to at least one theme group on the basis of the clustering model.

In one embodiment of the present invention, the method for extracting, in response to receiving the plurality of current messages in the conversation, feature information of each of the plurality of current messages is the same as the method for extracting, in response to receiving a plurality of historical messages from a historical voice conversation, feature information of each of the plurality of historical messages according to the present invention.

In one embodiment of the present invention, the plurality of current messages include at least one of text messages and voice messages. When the current message is a voice message, first the voice message can be converted into a text message, and then the resulting text message is processed.

In one embodiment of the present invention, there is further included at least one of: displaying a current message in the at least one theme group according to a predefined display mode; and highlighting an unresponsive message in one theme group of the at least one theme group.

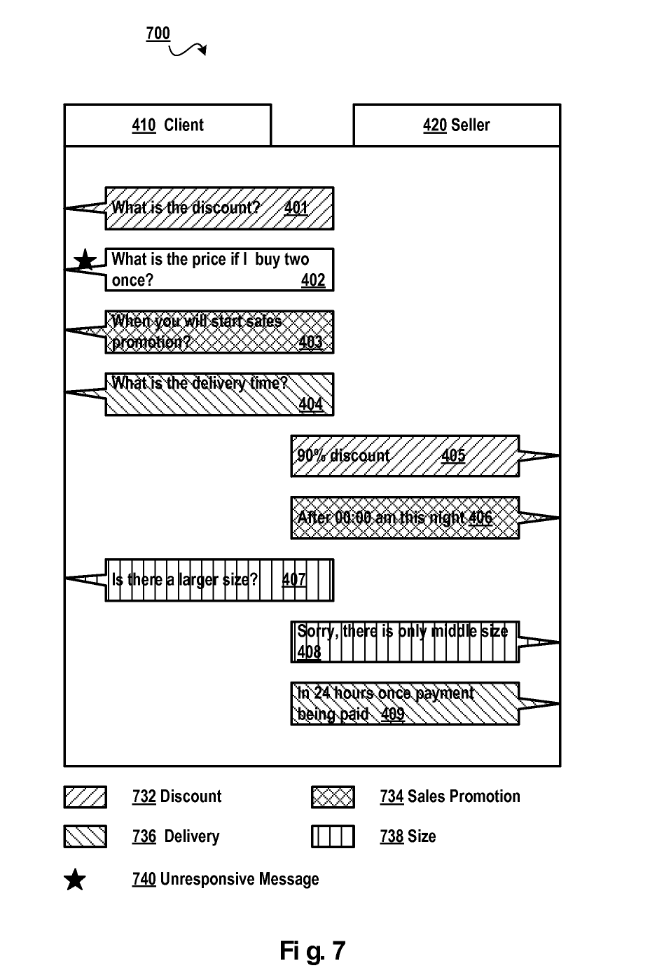

When theme groups have been obtained, messages in different theme groups can be displayed in different display modes. FIG. 7 shows schematic view 700 of an interface for displaying a plurality of clustered messages according to one embodiment of the present invention. Messages 401 to 409 in FIG. 7 are the same as the messages shown in FIG. 4, and the difference is that messages 401 to 409 have been clustered to different theme groups (e.g., discount, sales promotion, delivery, size, etc.) by using the method as shown in FIG. 6. Therefore, messages in different theme groups can be displayed in different display modes.

Specifically, messages in various groups can be displayed in display modes as discount 732, sales promotion 734, delivery 736 and size 738. For example, a theme group “discount” can include messages 401 and 405, so messages 401 and 405 are displayed in a display mode as shown by discount 732. For another example, a theme group “sales promotion” can include messages 403 and 406, so messages 403 and 406 can be displayed in a display mode as shown by sales promotion 734.

In one embodiment of the present invention, through clustering it can further be found that a certain clustering group only includes one message (e.g., message 402), i.e., the message is a question from client 410 whereas seller 420 gives no answer to the question. At this point, an unresponsive message in one theme group of the at least one theme group can be highlighted (e.g., represented as a star shown by a reference numeral 740).

Those skilled in the art should understand the “unresponsive message” in the context of the present invention is not limited to a message of question type (e.g., a question that is asked by one user but is not answered by the other user) but can include a message of statement type. For example, content of message 402 can read “I want to specify UPS for delivery.” Although message 402 is not of question type, since at this point seller 420 gives no response to message 402, it can be considered message 402 is an unresponsive message.

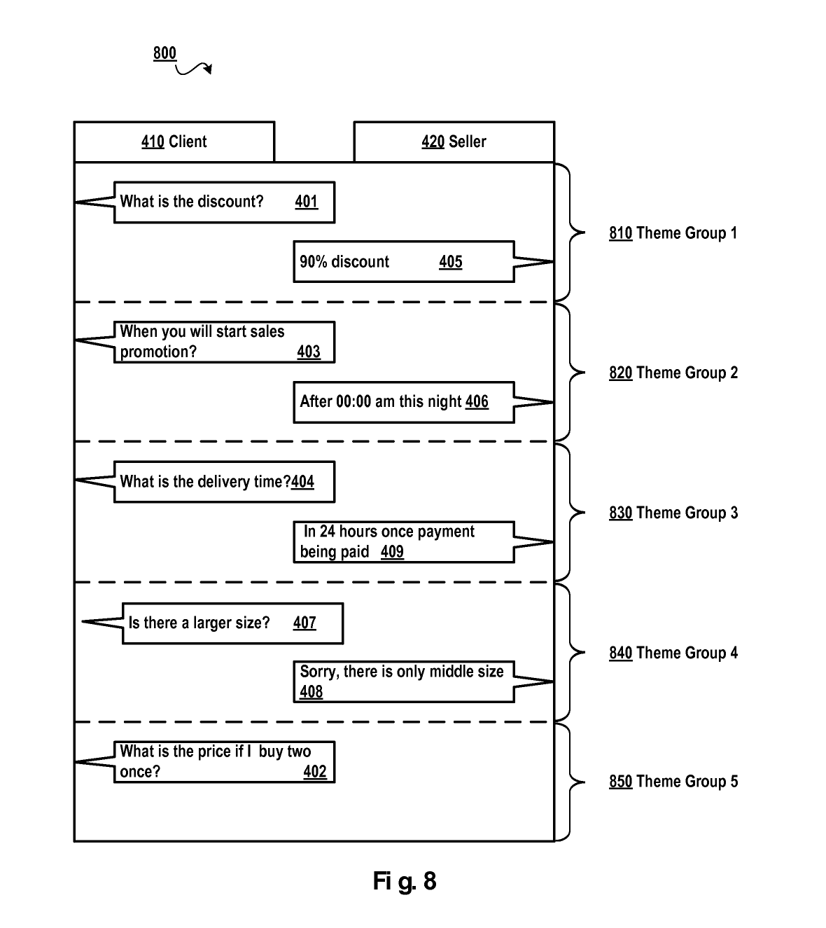

FIG. 8 shows schematic view 800 of an interface for displaying a plurality of clustered messages according to another embodiment of the present invention. Continuing the above example, when a plurality of theme groups 810 to 850 have been obtained, messages in each theme group can be displayed in a centralized manner. For example, messages 401 and 405 can be displayed in an area associated with theme group 1 810, messages 403 and 406 can be displayed in an area associated with theme group 2 820, . . . , message 402 can be displayed in an area associated with theme group 5 850, etc.

Those skilled in the art should understand although various embodiments of the present invention have been described in the context of the present invention by taking Chinese messages as a concrete example, the technical solution of the present invention can further be applied to messages written in other languages. In one embodiment of the present invention, messages can be written in Chinese, English, French or languages of other countries. At this point, historical voice conversations in a corresponding language are taken as the source of training data, and feature information and a correlation are generated on the basis of these conversations and further a training model in the corresponding language is generated. In one embodiment of the present invention, messages can further include two or more languages, at which point the two or more languages are taken as the source of training data.

Those skilled in the art should understand with the increase of the user conversation duration, users might continuously start new themes and discuss the new themes. Therefore, as a new message is coming, the clustering method of the present invention can be executed continuously. For the example shown in FIG. 4, when the conversation only includes messages 401 to 406, clustering groups can be obtained as below: discount, sales promotion, delivery and unresponsive message; when the conversation includes messages 401 to 409, more clustering groups can be obtained.

Those skilled in the art should understand the clustering model generated using the above method is not kept unchanged but is updated on the basis of, for example, theme groups resulting from clustering more and more messages. Those skilled in the art can update the clustering model that is generated on the basis historical voice conversations, by using a method for updating a clustering model that is known in the prior art or to be developed later.

Various embodiments implementing the method of the present invention have been described above with reference to the accompanying drawings. Those skilled in the art can understand that the method can be implemented in software, hardware or a combination of software and hardware. Moreover, those skilled in the art can understand by implementing steps in the above method in software, hardware or a combination of software and hardware, there can be provided an apparatus based on the same invention concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention. The apparatus described in the present invention includes several means or modules, the means or modules configured to execute corresponding steps. Upon reading this specification, those skilled in the art can understand how to write a program for implementing actions performed by these means or modules. Since the apparatus is based on the same invention concept as the method, the same or corresponding implementation details are also applicable to means or modules corresponding to the method. As detailed and complete description has been presented above, the apparatus is not detailed below.

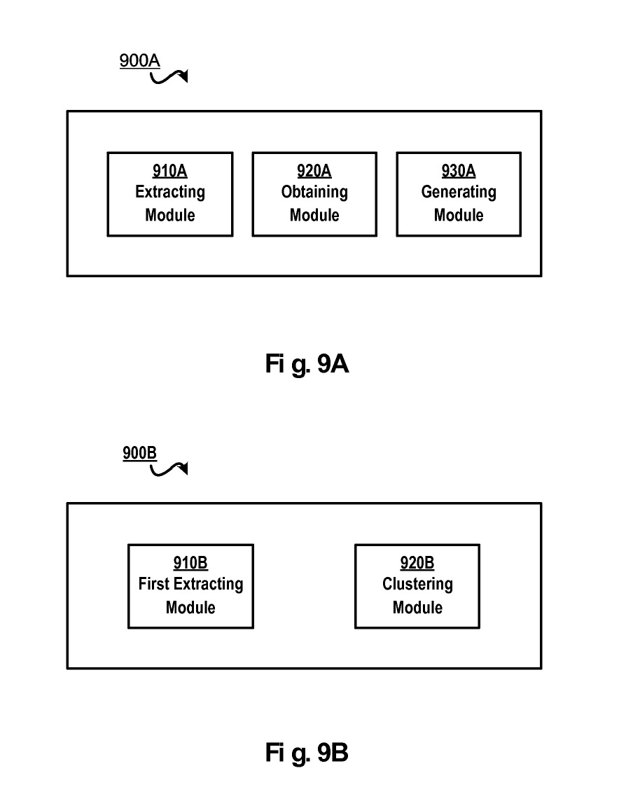

FIG. 9A schematically shows block diagram 900A of an apparatus for generating a clustering model according to one embodiment of the present invention. Specifically, in one embodiment of the present invention, there is provided an apparatus for generating a clustering model, including: extracting module 910A configured to extract feature information of each of the plurality of historical messages in response to receiving a plurality of historical messages from a historical voice conversation; obtaining module 920A configured to obtain a correlation between the plurality of historical messages; and generating module 930A configured to generate, on the basis of the correlation and the feature information of each of the plurality of historical messages, a clustering model that clusters the plurality of historical messages.

In one embodiment of the present invention, obtaining module 920A includes: an identifying module configured to identify historical messages that discuss the same theme among the plurality of historical messages as having the correlation.

In one embodiment of the present invention, generating module 930A includes: a training module configured to train the clustering model on the basis of the feature information and the correlation so that the clustering model clusters historical messages having the correlation to one theme group.

In one embodiment of the present invention, extracting module 910A includes: a first obtaining module configured to, with respect to a current historical message among the plurality of historical messages, obtain topic information of the current historical message; a second obtaining module configured to obtain attribute information of the current historical message; and an integrating module configured to integrate the topic information with the attribute information to form feature information of the historical message.

In one embodiment of the present invention, the first obtaining module includes: a vector obtaining module configured to obtain a topic vector describing the historical message; and an indicator obtaining module configured to cluster the topic vectors so as to obtain topic clustering indicators to which the topic vectors belongs, the topic information including the topic vector and the topic clustering indicator.

In one embodiment of the present invention, the second obtaining module includes: a parsing module configured to parse the attribute information of the current historical message from time-series information of the plurality of historical messages in the conversation, the attribute information including at least one of: time of the current historical message, and a distance between the current historical message and other historical message among the plurality of historical messages.

In one embodiment of the present invention, the second obtaining module includes: a comparing module configured to compare text of the current historical message with text of other historical message among the plurality of historical messages to obtain the attribute information of the current historical message, the attribute information including at least one of: linguistic feature information, n-gram based similarity information, and semantics based similarity information.

FIG. 9B schematically shows block diagram 900B of an apparatus for clustering a plurality of current messages in a current conversation on the basis of a generated clustering model according to one embodiment of the present invention. Specifically, there is provided an apparatus for clustering a plurality of current messages in a current conversation, including: first extracting module 910B configured to, in response to receiving the plurality of current messages in the current conversation, extract feature information of each of the plurality of current messages; and clustering module 920B configured to cluster the plurality of current messages to at least one theme group on the basis of the feature information of each of the plurality of current messages by using a clustering model generated by an apparatus of the present invention.

In one embodiment of the present invention, the plurality of current messages include at least one of text messages and voice messages.

In one embodiment of the present invention, there are further included: a display module configured to display a current message in the at least one theme group according to a predefined display mode; and a highlighting module configured to highlight an unresponsive message in one theme group of the at least one theme group.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating a clustering model, comprising:
extracting feature information of each of a plurality of historical messages in response to receiving the plurality of historical messages from a historical voice conversation;
obtaining a correlation between the plurality of historical messages; and
generating a clustering model that clusters the plurality of historical messages on the basis of the correlation and the feature information of each of the plurality of historical messages.

2. The method according to claim 1, wherein obtaining the correlation between the plurality of historical messages comprises:
identifying historical messages that discuss the same theme among the plurality of historical messages as having the correlation.

3. The method according to claim 2, wherein the generating the clustering model that clusters the plurality of historical messages on the basis of the correlation and the feature information of each of the plurality of historical messages comprises:
training the clustering model on the basis of the feature information and the correlation so that the clustering model clusters historical messages having the correlation to one theme group.

4. The method according to claim 1, wherein extracting the feature information of each of the plurality of historical messages in response to receiving the plurality of historical messages from the historical voice conversation with respect to a current historical message among the plurality of historical messages comprises:
obtaining topic information of the current historical message;
obtaining attribute information of the current historical message; and
integrating the topic information with the attribute information to form the feature information of the historical message.

5. The method according to claim 4, wherein obtaining topic information of the current historical message comprises:
obtaining a topic vector describing the historical message; and
clustering the topic vectors so as to obtain topic clustering indicators to which the topic vectors belongs.

6. The method according to claim 4, wherein obtaining the attribute information of the current historical message comprises:
parsing the attribute information of the current historical message from time-series information of the plurality of historical messages in the conversation, the attribute information comprising at least one of: (i) time of the current historical message and (ii) a distance between the current historical message and other historical message among the plurality of historical messages.

7. The method according to claim 4, wherein obtaining the attribute information of the current historical message comprises:
comparing text of the current historical message with text of other historical messages among the plurality of historical messages to obtain the attribute information of the current historical message, the attribute information comprising at least one of:
linguistic feature information, n-gram based similarity information, and semantics based similarity information.

8. A method for clustering a plurality of current messages in a current conversation in response to receiving the plurality of current messages in the current conversation based on a clustering model generated by a plurality of historical messages from a historical conversation, the method comprising:
extracting feature information of each of a plurality of historical messages from a historical voice conversation;
obtaining a correlation between the plurality of historical messages;
generating a clustering model that clusters the plurality of historical messages on the basis of the correlation and feature information of each of the plurality of historical messages;
extracting feature information of each of the plurality of current messages; and
clustering the plurality of current messages to at least one theme group on the basis of the feature information of each of the plurality of current messages by using the generated clustering model.

9. The method according to claim 8, wherein the plurality of current messages comprise at least one of text messages and voice messages.

10. The method according to claim 8, further comprising at least one of:
displaying a current message in the at least one theme group according to a predefined display mode; and
highlighting an unresponsive message in one theme group of the at least one theme group.

11. An apparatus for generating a clustering model, comprising:
an extracting module configured to extract feature information of each of a plurality of historical messages in response to receiving the plurality of historical messages from a historical voice conversation;
an obtaining module configured to obtain a correlation between the plurality of historical messages; and
a generating module configured to generate a clustering model that clusters the plurality of historical messages on the basis of the correlation and the feature information of each of the plurality of historical messages.

12. The apparatus according to claim 11, wherein the obtaining module comprises:
an identifying module configured to identify historical messages that discuss the same theme among the plurality of historical messages as having the correlation.

13. The apparatus according to claim 12, wherein the generating module comprises:
a training module configured to train the clustering model on the basis of the feature information and the correlation so that the clustering model clusters historical messages having the correlation to one theme group.

14. The apparatus according to claim 11, wherein the extracting module comprises:
a first obtaining module configured to obtain topic information of the current historical message with respect to a current historical message among the plurality of historical messages;
a second obtaining module configured to obtain attribute information of the current historical message; and
an integrating module configured to integrate the topic information with the attribute information to form feature information of the historical message.

15. The apparatus according to claim 14, wherein the first obtaining module comprises:
a vector obtaining module configured to obtain a topic vector describing the historical message; and
an indicator obtaining module configured to cluster the topic vectors and obtain topic clustering indicators to which the topic vectors belongs.

16. The apparatus according to claim 14, wherein the second obtaining module comprises:
a parsing module configured to parse the attribute information of the current historical message from time-series information of the plurality of historical messages in the conversation, the attribute information comprising at least one of: time of the current historical message, and a distance between the current historical message and other historical message among the plurality of historical messages.

17. The apparatus according to claim 14, wherein the second obtaining module comprises:
a comparing module configured to compare text of the current historical message with text of other historical messages among the plurality of historical messages to obtain the attribute information of the current historical message, the attribute information comprising at least one of: linguistic feature information, n-gram based similarity information, and semantics based similarity information.

18. An apparatus for clustering a plurality of current messages in a current conversation, comprising:
a first extracting module configured to extract feature information of each of the plurality of current messages in response to receiving the plurality of current messages in the current conversation; and
a clustering module configured to cluster the plurality of current messages to at least one theme group on the basis of the feature information of each of the plurality of current messages by using a clustering model generated by an apparatus according to claim 11.

19. The apparatus according to claim 18, wherein the plurality of current messages comprise at least one of text messages and voice messages.

20. The apparatus according to claim 18, further comprising:
a display module configured to display a current message in the at least one theme group according to a predefined display mode; and
a highlighting module configured to highlight an unresponsive message in one theme group of the at least one theme group.
